(19) United States
(12) Patent Application Publication
(10) Pub. No.: US 2007/0050593 A1
(43) Pub. Date: Mar. 1, 2007

(54) Interlaced even and odd address mapping

(75) Inventors: HuaYuan Chen, Singapore (SG); Yongpeng Chng, Singapore (SG); CheeSeng Toh, Singapore (SG); Wesley Chan, Singapore (SG); Pohguat Bay, Singapore (SG)

Correspondence Address: SHUMAKER & SIEFFERT, P. A., 8425 SEASONS PARKWAY, SUITE 105, ST. PAUL, MN, 55125, US

(73) Assignee: Seagate Technology LLC, Scotts Valley, CA (US)

(21) Appl. No.: 11/214,967

(22) Filed: Aug. 30, 2005

(51) Int. Cl. G06F 12/00

(52) U.S. Cl. 711/202; 711/112

(57) ABSTRACT

An interlaced even and odd mapping maps between a logical address space and a physical address space. In one embodiment, an interlaced even and odd mapping scheme provides for converting between a target logical block address (LBA) and a target physical disc sector or cylinder head sector (CHS). In other embodiments, the mapping may be used in any application wherein address translation is desired between address spaces. For example, the mapping may be used to convert between a target logical address space and a target physical address space in a digital computer environment that includes a data storage device, such as a disc drive, for persistent storage. The interlaced even and odd mapping scheme allows for larger physical sector sizes on the data storage device than the logical sector sizes on a host computer.

### TECHNICAL FIELD

The present invention relates generally to the field of data storage devices and, more particularly, to address translation between two address spaces.

### BACKGROUND

Computers typically include a host computer and a persistent data storage device that stores data. Examples of such data storage devices include magnetic disc drives, optical storage devices, and removable disc drives. The most basic parts of a disc drive are one or more rotatable information storage discs and an actuator that moves a transducer to various locations over the disc to either read information from or write information to the storage media. A disc drive also includes control electronics that manages the flow of data between the host computer and the data storage device, and controls positioning of the read/write heads for accessing desired sectors on the storage media.

Data storage devices typically comprise one or more discs mounted on the hub of a spindle motor for rotation at a constant high speed. Each storage surface of a disc is divided into several thousand tracks that are tightly packed concentric circles. The tracks are typically numbered starting from zero at the outermost track on the disc and increasing for tracks located closer to the center of the disc. Each track is further broken down into data sectors and servo bursts. A data sector is normally the smallest individually addressable unit of information stored in a disc drive and typically holds 512 bytes of information plus additional bytes for internal use by the drive for track identification and error correction. A storage cylinder is defined as a grouping of tracks across two or more recording surfaces that are substantially the same radial distance away from the center of a set of discs (e.g., having the same track number on the various surfaces). This organization of data allows for access to any part of the discs.

The physical geometry of a data storage device refers to its actual physical configuration, including the number of discs, number of tracks or cylinders, number of sectors per track, and number of heads. In some systems, the host computer may specify memory storage locations in terms of the actual physical disc addresses, for example, by specifying the actual physical location on the storage disc by cylinder, head, and sector (CHS) where the desired data are to be found or stored. On the other hand, to facilitate compatibility with a wide variety of host systems, most modern computer systems use so-called virtual or logical block addressing, wherein data are identified by a virtual or logical block address (LBA). As mentioned above, data storage devices are typically written to/read from in sector size blocks of 512 bytes. Host devices also typically use 512-byte sector size blocks to match the sector size of the data storage device. The necessary LBA to CHS address conversions take place under control of a local microprocessor associated with the data storage device.

### SUMMARY

The present invention is a method and apparatus for converting between a first address space and a second address space. In one embodiment, the invention is directed to a method and apparatus for converting between a logical address space and a physical address space. In particular, in one embodiment, the present invention is directed at converting between a target logical block address (LBA) and a target physical disc sector or cylinder head sector (CHS). In other embodiments, the present invention may be used in any application wherein address translation is desired between address spaces. An interlaced even and odd mapping provides for conversion between the two address spaces. In one embodiment, the present invention is used to convert between a target logical address and a target physical address in a digital computer environment that includes a data storage device for persistent storage.

The present invention may also be thought of as a data storage device having physical sector sizes larger than the logical sector sizes of a host computer. The data storage device partitions the logical address space and provides an interlaced even and odd mapping between the logical address space and the physical address space. The data storage device further converts between a target logical address and a target physical address using the interlaced even and odd mapping scheme.

In one embodiment, the invention is directed to a method including dividing a logical address space to create a plurality of partitions, and mapping the logical address space to a physical address space using an interlaced even and odd mapping. The method may also include storing the interlaced even and odd mapping in a partition table. The method may further include converting between a target logical address and a target physical address using the partition table.

In another embodiment, the invention is directed to an apparatus comprising a partition table that stores an interlaced even and odd mapping between a logical address space and a physical address space, and an address translator that references the partition table and converts between a target logical address within the logical address space and a target physical address within the physical address space.

In another embodiment, the invention is directed to a computer-readable medium containing instructions. The instructions cause a programmable processor to divide a logical address space to create a plurality of partitions, and map the logical address space to a physical address space using an interlaced even and odd mapping, such that consecutive partitions alternate between an even starting logical address and an odd starting logical address. The computer-readable medium may further include instructions to store the interlaced even and odd mapping in a partition table.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a top plan view of a disc drive incorporating an example embodiment of the present invention.

FIG. 2 is a functional block diagram of the disc drive of FIG. 1.

FIG. 3 is a diagram showing an example interlaced even and odd LBA mapping scheme.

FIG. 4 is a diagram showing an example of a partition table corresponding to the example mapping scheme of FIG. 3.

FIG. 5 is a flowchart illustrating converting a target logical address to a target physical address according to the interlaced even and odd mapping scheme of the present invention.

FIG. 6 is a flow chart illustrating converting from a target physical address to a target logical address according to the interlaced even and odd mapping scheme of the present invention.

### DETAILED DESCRIPTION

The present invention is a method and apparatus for converting between a target logical address and a target physical address. In particular, in one embodiment, the present invention is directed at converting between a target logical block address (LBA) and a target physical disc sector or cylinder head sector (CHS). In other embodiments, the present invention may be used in any application wherein address translation is desired between address spaces. In one embodiment, the present invention is used to convert between a target logical address and a target physical storage space in a digital computer environment that includes a data storage device for persistent storage. Thus, while many application environments are possible, the present invention will generally be described with respect to use with a digital computer system.

The present invention may also be thought of as a data storage device having physical sector sizes larger than the logical sector sizes of a host computer. The data storage device partitions the logical address space and provides an interlaced even and odd mapping between the logical address space and the physical address space. The data storage device further converts between a target logical address and a target physical address using the interlaced even and odd mapping scheme.

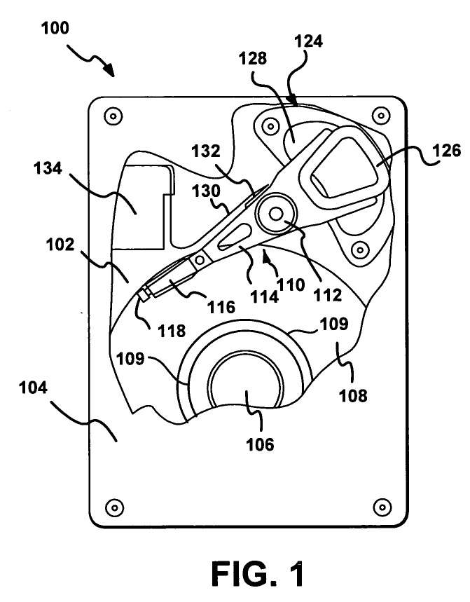

FIG. 1 shows a data storage device 100 constructed in accordance with a preferred embodiment of the present invention. In the embodiment, shown in FIG. 1, data storage device 100 is illustrated as a disc drive. However, it shall be understood that other types of data storage devices may also be used, and that the specific embodiment shown and described herein is for illustrative purposes only and is not a limitation of the present invention. In addition, it shall also be understood that the present invention may be used in any application wherein address translation is desired between address spaces.

The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 that rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 that extend towards the discs 108, with one or more flexures 116 extending from each of the actuator arms 114. Mounted at the distal end of each of the flexures 116 is a read/write head 118 which includes an air bearing slider (not shown) enabling the head 118 to fly in close proximity above the corresponding surface of the associated disc 108.

During a seek operation, the position of the read/write heads 118 over the discs 108 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected. The head wires are routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

As shown in FIG. 1, located on the surface of the discs 108 are a plurality of nominally circular, concentric tracks 109 (only one of which is shown). Each track 109 preferably includes a number of servo fields that are periodically interspersed with user data fields along the track 109. The user data fields are used to store user data and the servo fields used to store servo information used by a disc drive servo system to control the position of the read/write heads.

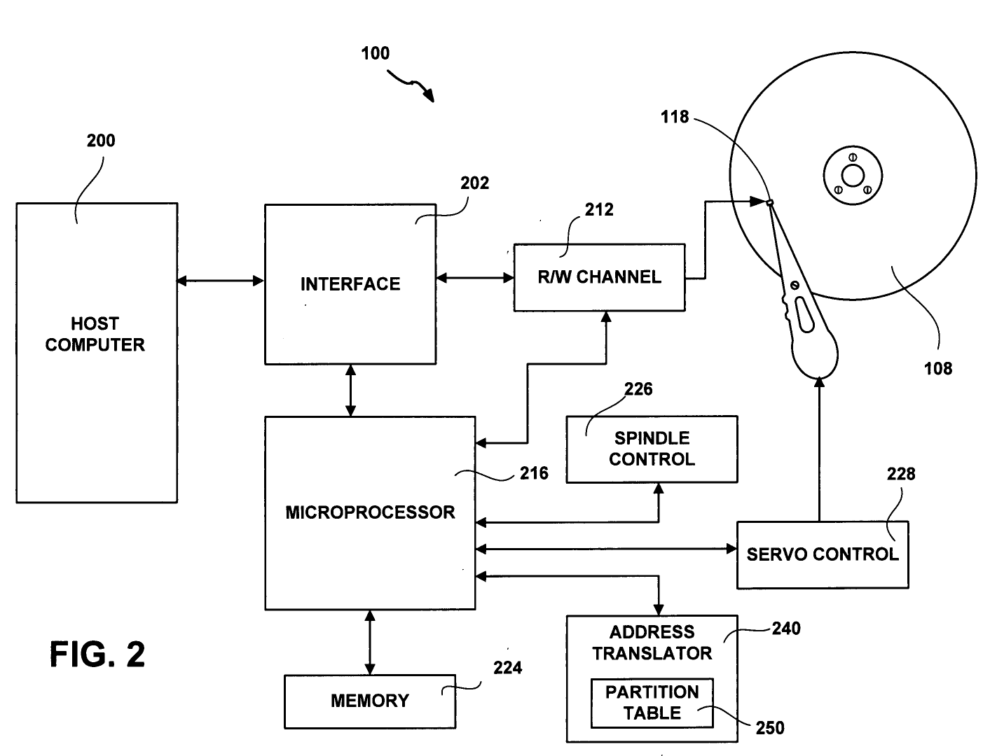

FIG. 2 provides a functional block diagram of the disc drive 100 of FIG. 1 operably connected to a host computer 200. As shown in FIG. 2, disc drive 100 includes control electronics coupled between host computer 200 and discs 108 that controls the flow of data between host computer 200 and discs 108, and controls positioning of the read/write heads 118 for accessing desired sectors on the discs 108. Disc drive 100 generally comprises or includes circuits or modules for spindle control 226, servo control 228 and read/write channel control 212, all operably connected to a system microprocessor 216. Additionally, an interface 202 is shown connected to the read/write channel 212 and to the system microprocessor 216, with interface 202 serving as a conventional data interface and buffer for the disc drive 100. Spindle control 228 controls the rotational speed of the spindle motor 106. Address translator 240 provides address translation between a logical address space of host computer 200 (such as LBA) to a physical address space (such as disc sector or CHS) on data storage device 100 in accordance with the present invention as described below.

In operation of the disc drive 100, servo control 228 receives servo position information from the tracks 109 via the read/write heads 118 and, in response thereto, provides a correction signal to the actuator coil 126 in order to position the heads 118 with respect to the discs 108. Read/write channel 212 operates to write data to the tracks 109 (FIG. 1) in response to user data provided to the channel from the interface 202 by encoding and serializing the data and generating a write current utilized by the heads 118 to selectively magnetize portions of a selected track 109 on the discs 108. Correspondingly, data previously stored on a track 109 are retrieved by the read/write channel 212 by reconstructing the data from the read signals generated by a head 118 as the head passes over the selected track 109 on the disc 108.

It will be noted that the various operations of the disc drive 100 may be controlled by the microprocessor 216, in accordance with programming stored in system microprocessor memory 224. Those skilled in the art will recognize that typical disc drives include additional circuitry and functions beyond those delineated above, but such are only of general interest to the present discussion and accordingly do not warrant further description.

The sector size of the data storage device 100 of the present invention may have a large sector size as compared to the sector size of host computer 200. For example, data storage device 100 may have sector size of 1024 bytes, 2048 bytes, 4096 bytes, or larger, whereas the host computer sector size is typically 512 bytes. As error correction encoding (ECC) becomes more powerful and recording densities increase, longer synchronization and timing areas are required for each sector, resulting in increased per block overhead. Increasing the data storage device sector block size from 512 bytes results in a decrease in total drive overhead, as fewer total sectors are required. An additional benefit of larger blocks is the reduction of inter-block gaps on the track. A larger block size may thus achieve faster seek times and greater format efficiency.

In order to accommodate disc sector sizes larger than those of the host computer, the present invention provides a scheme to minimize sector misalignment that may result when logical (host) and physical (disc) sector sizes are “mis-matched.” In a typical system, host commands may start from any logical address with any length of logical sector count. In addition, the physical address space is read from/written to in full physical sector length block sizes. By increasing the physical sector size to something larger than the logical sector size, as proposed by the present invention, host commands may result in reads/writes of blocks that are not full physical sector sizes in length. This may deteriorate write performance as each “misaligned” write operation will incur a hidden read. In other words, to perform a partial write, the data storage device may need to perform a read operation to retrieve the data of the entire sector, merge the sector data with the host data, and then write back the merged sector data to the disc. The interlaced even and odd mapping scheme of the present invention provides a distribution of even and odd mappings throughout the logical address space, thus reducing sector misalignment and minimizing any concomitant deterioration in disk drive write performance.

The present invention provides a method and apparatus for converting between a logical address space of a host computer to a physical address space of a data storage device. In particular, the present invention provides an interlaced even and odd mapping scheme for converting between a target logical address and a target physical address, and vice versa. The interlaced even and odd mapping scheme will be generally described with respect to converting between a target logical address such as LBA and a target physical address, such as physical disc sector number or CHS. It shall be understood, however, that the present invention may be used in any application wherein address translation is desired between address spaces without departing from the spirit and scope of the present invention, and that the invention is not limited in this respect.

Address translator 240 converts between a target logical address and a target physical address by means of an interlaced even and odd mapping scheme. Address translator 240 includes a partition table 250 that stores the mapping information to allow conversion between the logical and physical address spaces as described below.

In one embodiment, address translator 240 may include software executed by microprocessor 216 to achieve the address translation. If implemented in software, the invention may be directed to a computer readable medium comprising program code that can be executed in by microprocessor 216 or similar device to perform logical to physical address translation as described herein. In other embodiments, address translator 240 may be implemented in computer hardware or computer firmware, such as ROM, EEPROM, flash memory, and the like. In any event, address translator 240 is configured to convert between a target logical address on the host computer to a target physical address on the data storage device by means of an interlaced even and odd mapping. It shall be understood that the phrase “convert between a target logical address and a target physical address” refers to both converting from a target logical address to a target physical address and converting from a target physical address to a target logical address.

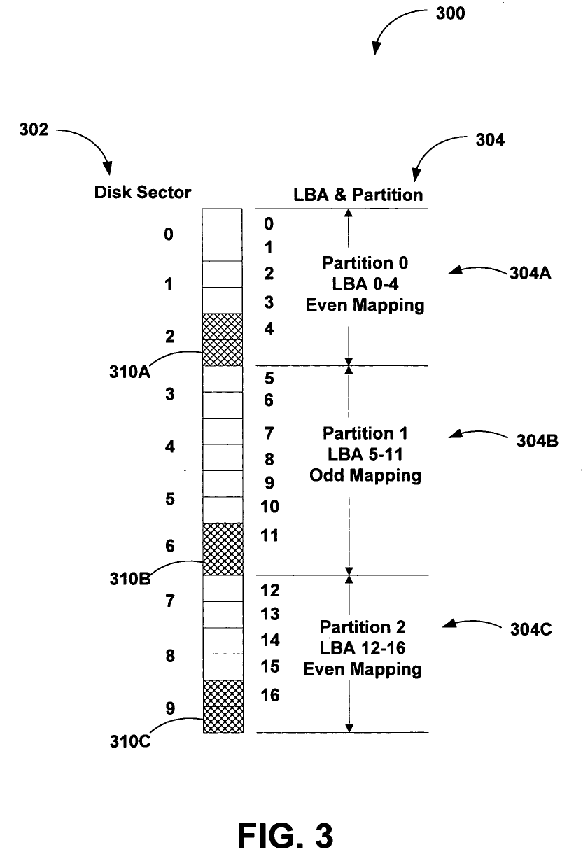

FIG. 3 is a diagram showing an example interlaced even and odd mapping scheme 300 for converting between a logical address space (host LBA) and physical address space (physical disc sector number or CHS). In this embodiment, the entire LBA range is partitioned into several bands. In this embodiment, two consecutive LBAs are mapped to one disc sector. Each partition has a mapping scheme or partition type (e.g., even or odd) different from its neighboring partitions. The starting LBA for each partition determines whether the partition type is an even or an odd mapping. For even partitions, two consecutive LBAs starting with an even number are mapped to one disc sector. For odd partitions, two consecutive LBAs starting with an odd number are mapped to one disc sector. To achieve interlaced even and odd partition mappings, the last logical sector of each partition is partially mapped to ensure an alternating pattern of even and odd partitions. In general, the interlaced even and odd mapping scheme maps a partitioned logical address space to a physical address space such that consecutive partitions alternate between an even starting logical address and an odd starting logical address.

For example, mapping 300 illustrates how an example host LBA range 0 through 16 is mapped to disc sectors 0 through 9. In this example embodiment, there are three partitions 304A, 304B, and 304C. Partition 304A is an even mapping (disc sector 0 to LBA 0). Partition 304B is an odd mapping (disc sector 3 to LBA 5). Partition 304C is an even mapping (disc sector 7 to LBA 12). The last logical sector of each partition is partially mapped, e.g., LBA 4 is mapped to the first half of disc sector 2, LBA 11 is mapped to the first half of disc sector 6, and LBA 16 is mapped to the first half of disc sector 9. This partial mapping leaves the second half of disc sectors 2, 6, and 9 (denoted by reference numerals 310A, 310B, and 310C, respectively) unmapped, ensuring that the starting LBAs of consecutive partitions achieve an alternating pattern of even and odd mappings. In other words, Disc sectors that are partially mapped are referred to herein as “orphan sectors.” In FIG. 3, therefore, disc sectors 2, 6 and 9 are orphan sectors.

Referring again to FIG. 2, address translator 240 includes a partition table 250 that stores mapping information for each partition to allow conversion between a target logical address and a target physical address. Partition table 250 considers any incomplete or partial mappings during logical to physical address conversion and vice versa by virtue of a logical address compensation field in partition table 250.

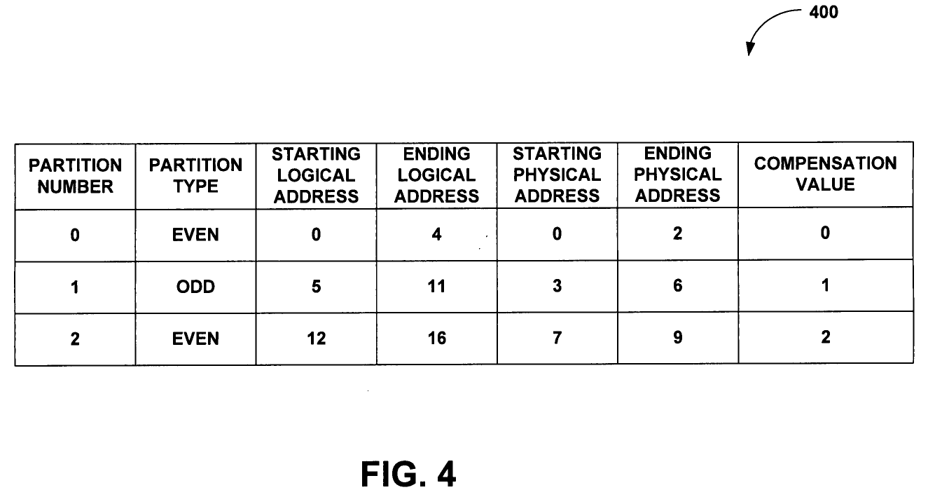

FIG. 4 shows an example of a partition table 400. The values in partition table 400 correspond to the example mapping scheme 300 shown in FIG. 3. Each entry of partition table 300 consists of the following fields:

Partition Number

Partition Type—even or odd mapping

Partition Starting Logical Address

Partition Ending Logical Address

Partition Starting Physical Address

Partition Ending Physical Address

Compensation Value—adjustment for orphan sectors

The compensation value field accounts for the total number of orphan sectors prior to the partition (excluding the partition itself). For example, the compensation value for partition 0 is zero, as there are no orphan sectors before partition 0. The compensation value for partition 1 is one, as there is one orphan sector (disc sector 2) before partition 1. The compensation value for partition 2 is two, as there are two orphan sectors (disc sector 2 and disc sector 6) before partition 2.

Although the example mapping shown in FIG. 3 and the example partition table shown in FIG. 4 give an example of a mapping between an LBA/logical address space and a CHS/physical address space, it shall be understood that the principles of the present invention apply anytime address conversion is required between two address spaces, whether they be logical, physical, or any combination thereof.

The total number of partitions of the logical address space, the number of logical addresses (e.g., LBAs) per partition, the number of physical addresses (e.g., disc sectors) per partition, the number of orphan sectors, the number of logical addresses mapped to each physical address, and/or the compensation value may vary depending upon the size of the logical and physical address spaces, host accessing patterns, the particular application involved, and the like. It shall be understood, therefore, that the embodiments given herein are for exemplary purposes only, and that the invention is not limited in these respects.

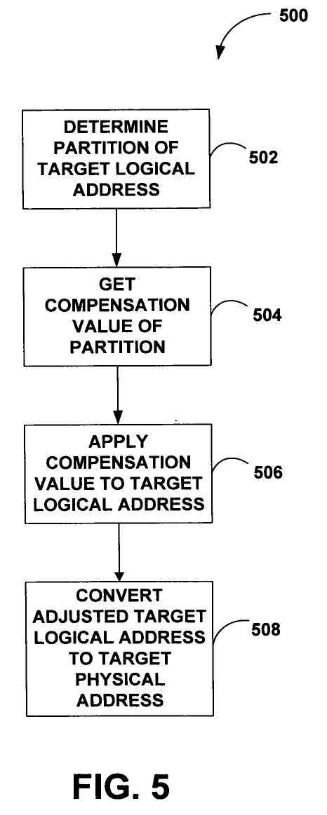

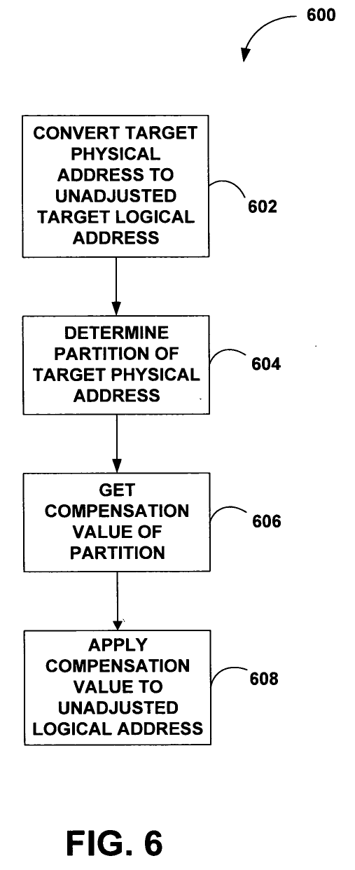

A description of the process by which address translator 240 converts between a target logical address and a target physical address using the interlaced even and odd mapping scheme will now be described with respect to FIGS. 5 and 6. Conversion between a target LBA and a target disc sector number will be given as specific examples.

FIG. 5 is a flowchart illustrating the process 500 by which address translator 240 converts a target logical address to a target physical address (500). Address translator 240 determines the partition of the target logical address (502). Address translator 240 then gets the compensation value associated with that partition (504). In one embodiment, address translator 240 refers to partition table 400 to get the compensation value associated with that partition. Address translator 240 applies the compensation value to the target logical address to arrive at an adjusted logical block address (506). Address translator 240 then converts the adjusted logical block address to the target physical address (508).

For example, assume that the target logical address is LBA 9 as shown in FIG. 3. LBA 9 falls within partition 1 (502). Referring to partition table 400 shown in FIG. 4, the compensation value of partition 1 is one (504). The adjusted LBA is 10 (target LBA+compensation value=9+1=10) (506). Dividing this sum by 2 results in a target disc sector number of 5 (10/2=5) (508). The mathematical operations required to adjust the target logical address via the compensation value and to convert the adjusted target logical address to the target physical address may vary depending upon the specific implementation of the interlaced even and odd mapping scheme (for example, the number of disc sectors mapped to each LBA, the number of orphan sectors, etc.) and it shall be understood that the specific embodiments described herein are for exemplary purposes only.

FIG. 6 is a flow chart illustrating the process by which address translator 240 converts a target physical address to a target logical address according to the interlaced even and odd mapping scheme of the present invention (600). In this example, the process is essentially the reverse of the process (500) shown in FIG. 5; however, this need not be the case in all embodiments. Address translator 240 converts the target physical address to an unadjusted target logical address (602). Address translator 240 also determines the partition of the target physical address (604). Address translator 240 then refers to partition table 400 to get the compensation value associated with that partition (606). In one embodiment, address translator 240 refers to partition table 400 to determine the compensation value of that partition. Address translator 240 applies the compensation value to the unadjusted target logical address to arrive at the target logical address (608).

For example, assume that the target sector is disc sector 8. Because in this example mapping two consecutive LBAs share the same disc sector (except for orphan sectors), conversion from a disc sector to an LBA will always get the smaller one of the two LBAs. Multiplying the target sector by 2 gives 16 (8*2=16) (602). Disc sector 8 falls within partition 2 (604). The compensation value of partition 2 is 2 (606). Subtracting the compensation value from the multiplied target sector results in an LBA of 14 (16-2=14) (608). Again, the mathematical operations required to convert the target physical address to an unadjusted target logical address and to apply the compensation value to the unadjusted target logical address may vary depending upon the specific implementation of the interlaced even and odd mapping scheme (for example, the number of disc sectors mapped to each LBA, the number of orphan sectors, etc.) and it shall be understood that the specific embodiments described herein are for exemplary purposes only.

Address translator 240 is shown for conceptual purposes in FIG. 2 as a functional block separate from other functional modules of disc drive 100. However, the techniques described herein may be implemented in hardware, software, firmware, or any combination thereof. The invention may be embodied as a computer-readable medium that includes instructions for causing a programmable processor to carry out the methods described above. For example, the computer readable medium may comprise random access memory (RAM), read-only memory (ROM), non-volatile random access memory (NVRAM), electrically erasable programmable read-only memory (EEPROM), flash memory, magnetic or optical media, or the like.” The instructions may be implemented as one or more software modules, which may be executed by themselves or in combination with other software.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The invention may be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), Application Specific Integrated Circuit (ASIC), and the like.

The invention may be capable of providing one or more advantages. For example, the techniques described herein provide for larger disc sector sizes while minimizing sector misalignment that may result from mismatched host and disc sector sizes. The interlaced even and odd mapping scheme of the present invention provides a distribution of even and odd mappings throughout the logical address space, thus reducing sector misalignment and minimizing any concomitant deterioration in disk drive write performance.

Various embodiments of the invention have been described. These and other embodiments are within the scope of the following claims.

1. A method comprising:
partitioning a logical address space; and
mapping the partitioned logical address space to a physical address space such that consecutive partitions of the logical address space alternate between even and odd partition mappings.

2. The method of claim 1, further including storing the mapping in a partition table.

3. The method of claim 1, wherein an even partition mapping has an even starting logical address, and wherein an odd partition mapping has an odd starting logical address.

4. The method of claim 1, further including referencing the mapping to convert between a target logical address and a target physical address.

5. The method of claim 4, wherein the mapping includes a compensation value corresponding to each partition of the logical address space, and wherein converting between a target logical address and a target physical address comprises:
determining the partition of the target logical address;
referencing the mapping to obtain the compensation value corresponding to the partition of the target logical address;
applying the compensation value to the target logical address to arrive at an adjusted target logical address; and
converting the adjusted target logical address to the target physical address.

6. The method of claim 1, further comprising partially mapping at least one physical sector in each partition.

7. The method of claim 1, wherein the logical address space is a logical block address (LBA) address space and the physical address space is a disc sector address space.

8. The method of claim 7, wherein mapping the partitioned logical address space to a physical address space comprises:
mapping two consecutive LBAs to one disc sector; and
partially mapping at least one physical disc sector of each partition to one LBA.

9. The method of claim 7, further comprising converting between a target LBA and a target disc sector.

10. The method of claim 7, further comprising storing the mapping in a partition table.

11. An apparatus, comprising:
a partition table that stores an interlaced even and odd mapping between a logical address space and a physical address space; and
an address translator that references the partition table and converts between a target logical address within the logical address space and a target physical address within the physical address space.

12. The apparatus of claim 11, wherein the logical address space is a logical block address (LBA) address space and the physical address space is a cylinder head sector (CHS) address space.

13. The apparatus of claim 12, wherein the partition table divides the logical address space to create a plurality of partitions.

14. The apparatus of claim 13, wherein the partition table maps two consecutive logical block addresses to one disc sector in the cylinder head sector address space, and partially maps at least one physical disc sector of each partition to one logical block address.

15. The apparatus of claim 11, wherein the partition table stores, for each partition, a partition type, a starting logical address, an ending logical address, a starting physical address, an ending physical address, and a compensation value.

16. A computer-readable medium comprising instructions to cause a processor to:
partition a logical address space; and
map the partitioned logical address space to a physical address space such that consecutive partitions of the logical address space alternate between even and odd partition mappings.

17. The computer-readable medium of claim 16, further comprising instructions cause a processor to store the mapping in a partition table.

18. The computer-readable medium of claim 16, further comprising instructions to cause a processor to convert a target logical address to a target physical address using the mapping.

19. The computer-readable medium of claim 18, wherein an even partition mapping has an even starting logical address and an odd partition mapping has an odd starting logical address.
